(19) United States
(12) Patent Application Publication
(10) Pub. No.: US 2024/0383389 A1
(43) Pub. Date: Nov. 21, 2024

(54) SEAT COMPONENT, SEAT AND METHOD FOR PRODUCING A SEAT COMPONENT

(71) Applicant: Adient US LLC, Plymouth, MI (US)

(72) Inventor: Thomas DILLINGER, Ratingen (DE)

(73) Assignee: Adient US LLC, Plymouth, MI (US)

(21) Appl. No.: 18/693,204

(22) PCT Filed: Sep. 21, 2022
(86) PCT No.: PCT/IB2022/058918

§ 371 Date: Mar. 19, 2024

(30) Foreign Application Priority Data
Sep. 22, 2021 (DE) 10 2021 210 556.4
Dec. 22, 2021 (DE) 10 2021 214 915.4

(51) Int. Cl. B60N 2/70; B29C 44/12; B29L 31/58; B60N 2/64

(52) U.S. Cl. CPC B60N 2/7017; B29C 44/1209; B60N 2/64; B29L 2031/58

(57) ABSTRACT

A molded body for a seat component, in particular a backrest or a seat part of a seat may have at least one thermally solidified and three-dimensionally formed nonwoven element which is back-molded with a foam material or a foamable material. An additional molded body and a method for producing such a molded body are also disclosed.

The invention relates to a seat component, such as a backrest or a seat part, for example, a seat, particularly a vehicle seat having a seat component of this kind, and a method for producing a seat component of this kind.

Seats, in particular vehicle seats, which are formed as lightweight seats made of foam parts with multiple foam layers of varying hardness and/or density are known in the art. A foam part of this kind for a vehicle seat is disclosed in WO 2014/106592 A1, for example.

The object of the present invention is to improve a seat component of a seat, in particular a vehicle seat, in particular to reduce the weight and/or thickness thereof and to simplify the structure thereof. Furthermore, a seat with an improved seat component and a method for producing a seat component according to the invention must be provided.

The object is achieved according to the invention with a seat component, in particular a backrest or a seat part of a seat, in particular of a vehicle seat, according to the features of claim 1. Furthermore, the object with respect to the seat is achieved by the features of claim 11, and with respect to the method by the features of claim 12.

A seat component according to the invention, in particular a backrest or a seat part of a seat, comprises at least a seat structure and a molded body comprising at least one thermally solidified and three-dimensionally formed nonwoven element that is back-molded with a foam material or a foamable material, wherein the seat structure is arranged in a cavity of the at least one nonwoven element and is foamed in by the foam material or the foamable material. As an alternative to the integrated or injection-molded variant of the seat structure, this can be mechanically fastened to the molded body after the foam material or the foamable material of the back-molded nonwoven element on the molded body has cured. In particular, the seat structure is mechanically attached on the side of the molded body facing away from the nonwoven element.

A cavity of the at least one nonwoven element is understood to mean, in particular, a mold cavity on a back side or rear side of the nonwoven element which is particularly shell-shaped. The nonwoven element may form a shell part of a foam mold, for example. A molded part of the foam mold may form an opposing shell part of the foam mold. The intermediate cavity between the nonwoven element, as the first shell part, and the molded part, as the second shell part, forms the mold cavity on the back side of the nonwoven element.

The molded body for the seat component, in particular a backrest or a seat part of a seat, particularly a vehicle seat, comprises at least the thermally solidified and three-dimensionally formed nonwoven element, which is back-molded with the foam material or foamable material.

The advantages achieved with the invention particularly involve the inventive seat component with the molded body being capable of being produced easily, quickly, and cost-effectively, and used directly as a cover-free bearing surface, in particular a seat surface or backrest surface, of the seat.

The molded body of the seat component, and therefore the seat component itself, is ergonomically thermally solidified and formed. Plastic is used as the material, for example. A seat component of this kind with a molded body of this kind is particularly thin and lighter-weight.

Another molded body for the seat component, in particular a backrest or a seat part of a seat, particularly a vehicle seat, can be formed by at least two thermally solidified and three-dimensionally formed, in particular three-dimensionally thermoformed, nonwoven elements, between which a foam material or foamable material is injected. The foam material or foamable material is designed as a support element and/or cushioning element and solidifies the nonwoven element in addition. A comfortable cushion body can be formed using the foam material or foamable material.

The foam material or foamable material forms a positive and/or adhesive bond with the at least one nonwoven element. This results in a one-piece, three-dimensional molded body being formed or formable. When the molded body is formed as a seat component, the nonwoven element forms a support surface or bearing surface for a user. In particular, the nonwoven element forms a user-facing, in particular three-dimensional, bearing surface, such as a seat surface of a seat part or a back surface of a backrest.

For example, the molded body is formed from only one thermally solidified and three-dimensionally formed nonwoven element which is, for example, back-molded with a foam material or a foamable material. A molded body of this kind formed from only one thermally solidified and thermoformed nonwoven element that is back-molded with foam enables a one-piece and three-dimensional thermally solidified and thermoformed seat shell that can be mounted on a supporting seat structure.

The advantages achieved with the invention include, in particular, the fact that the seat component according to the invention with a molded body of this kind can be produced easily, quickly, and cost-effectively, and can be directly used as a cover-free bearing surface, in particular a seat surface or backrest surface, for the seat. In this case, one of the nonwoven elements, for example a nonwoven element arranged on the front side, forms the bearing surface, and the other nonwoven element, for example a nonwoven element arranged on the rear side, forms a visually high-quality back surface, decorative surface, or support surface. The molded body according to the invention of the seat component according to the invention is ergonomically thermally solidified and formed. Plastic, for example, is used as the material. A molded body of this kind is particularly thin and lighter weight in design. The foam material or the foamable material is designed as a support element and/or cushioning element and additionally solidifies the nonwoven elements. A comfortable cushion body can be formed by the foam material or the foamable material.

For example, two nonwoven elements can be arranged opposite one another, forming a cavity between them, in particular an intermediate cavity or a closed mold cavity, in which the seat structure is arranged, and foam material or a foamable material is injected or already present, and the seat structure is foamed or overmolded in its cured state.

The cavity between nonwoven elements is taken to mean, in particular, an intermediate cavity between the two nonwoven elements. Each of the two nonwoven elements can form a shell part of a foam mold. The cavity lying between these two nonwoven elements formed as shell parts constitutes the mold cavity.

In this case, the foam material can expand into a cavity or space formed between the particularly thermoformed, preassembled, or prefixed nonwoven elements and connect to the nonwoven elements in a form-fitting and/or substance-bonded manner.

The molded body for the seat component which is formed from two thermally solidified and three-dimensionally formed, in particular pre-solidified and preformed, nonwoven elements and is internally expanded for the seat component results in a one-piece, three-dimensionally thermally solidified and thermoformed seat shell. A one-piece, three-dimensionally thermally solidified and thermoformed seat shell of this kind, consisting of the two nonwoven elements and the foamed cavity or intermediate space with the foamed or overmolded seat structure (also referred to as an integrated seat structure) is highly rigid, thin, and particularly lightweight, and offers good seating comfort. A one-piece, three-dimensionally thermally solidified and thermoformed molded body of this kind with an integrated seat structure acts as the seat shell and support shell of the seat and is also referred to as a soft seat shell. Additional padding is not required.

In both embodiments, the thermally solidified and thermoformed nonwoven element forms the seat surface of the respective seat component of the seat. In this case, a backrest has a thermally solidified and thermoformed nonwoven element on both sides, facing both forwards and backwards. The forward-facing nonwoven element in this case acts as a bearing surface for the back of a seat user. The backward-facing nonwoven element acts as a cover for the backrest towards the rear, for example in the direction of a rear row of seats or a rear seat. A seat part of the seat has, for example, a thermally solidified and thermoformed nonwoven element only in the direction of the seat user. In the direction of the vehicle floor, the nonwoven element is back-molded with foam material.

In addition, the molded body may include another thermally solidified and three-dimensionally formed nonwoven element. This additional thermally solidified and three-dimensionally formed nonwoven element may have lower density and/or lower strength than the nonwoven elements of the seat shell. This additional thermally solidified and three-dimensionally formed nonwoven element may be designed as an additional cushion body or additional cushioning element and may be arranged on and fastened to the thermally solidified and three-dimensionally formed molded body or seat body, in particular the seat shell.

In the embodiment of the molded body with at least two nonwoven elements, one of the two nonwoven elements may have lower density and/or lower strength than the other nonwoven element. For example, the nonwoven element arranged on the rear side has a higher density and/or higher strength, in order to be arranged on a seat support structure, such as a seat frame, for example, and to fulfil an adequate support and/or cushioning function. The nonwoven element arranged on the front side, which is designed as a bearing surface for a user, may have lower density and/or lower strength, in order to provide a comfortable bearing surface. Both nonwoven elements are arranged opposite one another and form a cavity between them, in which the foam material or the foamable material is injected. The foam material or foamable material is connected to the nonwoven elements in a form-fitting and/or substance-bonded manner. For example, no additional fastening elements are needed, in order to secure or connect the two nonwoven elements. The foam material or the foamable material is connected to the respective nonwoven element, thereby connecting them to one another. An integral three-dimensional molded body is thereby formed or can be formed.

In a further development, the at least one nonwoven element or both nonwoven elements is/are at least partially made of a plastic fiber material.

The seat, in particular a vehicle seat, may comprise a backrest as the seat component. The seat may comprise a seat part as the seat component. The backrest may be fastened to the seat part. The backrest may be pivotally fastened to the seat part, in particular by at least one fitting, in particular a swivel fitting or a latch fitting.

The thermally solidified and three-dimensionally formed nonwoven elements and/or the additional thermally solidified and three-dimensionally formed nonwoven element are formed, in particular, from a plastic fiber material, in particular from polyester fibers. In addition, the nonwoven elements may comprise polypropylene fibers. The nonwoven elements may be made of the same plastic fiber material. Alternatively, these nonwoven elements may be made of different plastic fiber materials. The nonwoven elements May have different levels of strength and/or density. In particular, the nonwoven elements may be differently configured at least in parts, in particular having a different density and/or strength.

For example, the nonwoven element in each case may have a grammage of 400 to 1200 grams per square meter, in particular a grammage of 900 grams per square meter. The respective nonwoven element preferably has a grammage of 850 grams per square meter to 950 grams per square meter.

The thermally solidified and three-dimensionally formed and foamed or back-molded molded body in each case is also referred to as the thermally solidified and thermoformed, in particular 3D-formed, seat shell, in particular 3D-formed thermoplastic seat shell or 3D-formed thermo-nonwoven shell. For example, the molded body may be formed solely from the thermally solidified and three-dimensionally formed and expanded or back-molded seat shell. The molded body may be formed, for example, from the thermally solidified and three-dimensionally formed and foamed or back-molded seat shell and the additional thermally solidified and three-dimensionally formed cushion body, in particular a cushion shell. The seat shell and the cushion body have three-dimensional shapes corresponding to one another, so that the cushion body is arranged in a form-fitting manner and attached to the seat shell in the assembled state.

In other words, the nonwoven element or the two nonwoven elements can be partially or completely permeated by the foam material or foamable material. Alternatively, the respective nonwoven element may not be permeated by the foam material or foamable material.

Additionally or alternatively, the respective nonwoven element, for example on a front side, may be provided with at least one recess. For example, the recess may be in the shape of a through-hole, a groove, or a slot. In particular, each nonwoven element forming a bearing surface or seat surface has at least one recess, in particular one or several longitudinal recesses or longitudinal slots. The recess is particularly used for the arrangement of attachments, such as a cushion element, an additional pad, or the like, for example.

The seat component in each case may comprise a supporting seat structure. In a possible embodiment, the supporting seat structure may be foamed into the foam material between the two nonwoven elements of the molded body. In this case, the two nonwoven elements may be arranged against the supporting seat structure and mounted in such a manner that they act as injection molding shells, between which a cavity or gap is formed, into which the foam material or a foamable material can be injected to form a foam body. A molded body of this kind comprises an injected seat structure. Alternatively, the molded body, in particular the thermally solidified and three-dimensionally formed and back-molded seat shell, may be mounted on the seat structure.

The advantages achieved with the invention include, in particular, the fact that a molded body of this kind and a seat component can be produced from a molded body of this kind in a particularly lightweight, simple, and cost-effective manner. In addition, sewing steps can be avoided. A covering element is not required. A seat shell of this kind can be manufactured universally for many applications. Customizations of the seat are made possible by attachments that can be attached and fastened to the seat shell afterwards.

Fastening elements, in particular hook-and-loop fasteners, adhesives, hook elements, etc., can be arranged on, in, and/or at the molded body, in order to fasten, for example, an attachment element such as a seat cushion, for example, in particular a cushion pad, a heating element, in particular a heating mat, a bag, a tray, in particular a mobile phone tray with an optional wireless charging function, and/or wireless ambient lighting, to the molded body, in particular subsequently.

In a first example of a method according to the invention for producing a molded body for a seat component, for example a seat part of a seat, at least one nonwoven element is thermally solidified and three-dimensionally formed, which is then back-molded with a foam material or foamable material. For this purpose, for example, the nonwoven element is arranged opposite a part of a foam mold, wherein a cavity is formed between them, in which the foam material or the foamable material is injected.

In a second example of a method according to the invention for producing a molded body for a seat component, for example a backrest of a seat, at least two nonwoven elements are thermally solidified and three-dimensionally formed, in particular thermally solidified and thermoformed. Subsequently, the two nonwoven elements are arranged on and fixed to one another in such a way that a cavity is formed between them, into which a foam material or foamable material is injected, which is connected to the nonwoven elements in a form-fitting and/or force-fitting manner and forms an inner foam body.

Optionally, before introducing the foam material or foamable material, a supporting seat structure can be optionally arranged in the cavity. This supporting seat structure is then foamed into the cavity or gap by the foam material or foamable material. Alternatively, the molded body can be mounted on a supporting seat structure.

Furthermore, another thermally solidified and three-dimensionally formed nonwoven element can be fastened to the molded body, in particular to a seat shell, as an attachment element. This additional thermally solidified and three-dimensionally formed nonwoven element is designed as a cushion body and is fastened to a surface of the molded body facing towards a seat user.

Exemplary embodiments of the invention are explained in greater detail with the help of drawings. In the drawings:

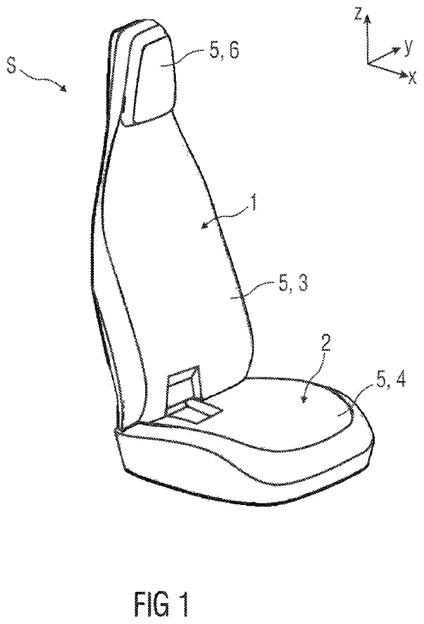

FIG. 1 shows schematically in a perspective view a seat comprising two seat components,

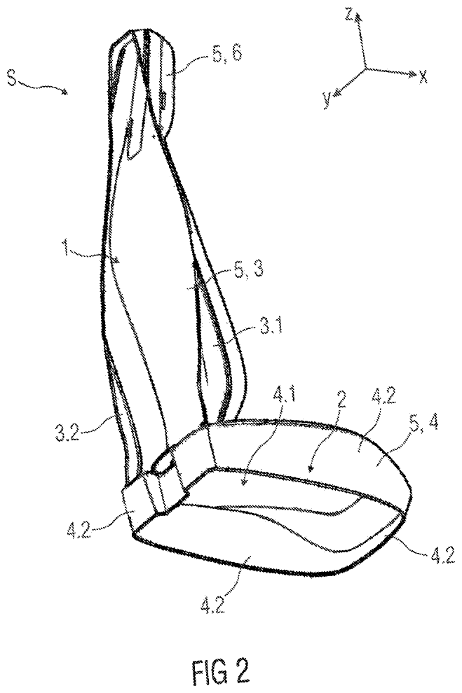

FIG. 2 shows schematically in a perspective, partially transparent view a seat comprising two seat components,

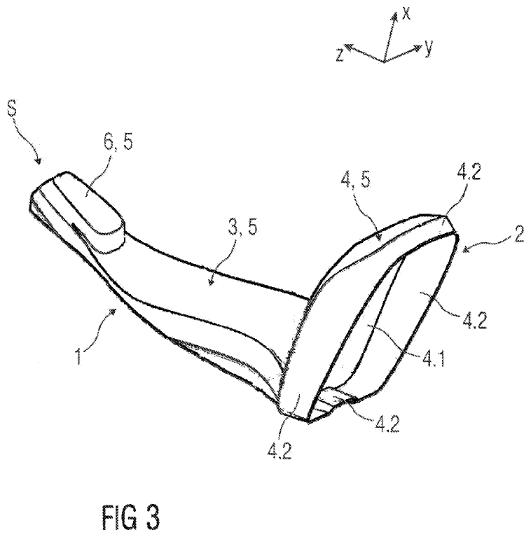

FIG. 3 shows schematically another perspective view of a seat comprising two seat components,

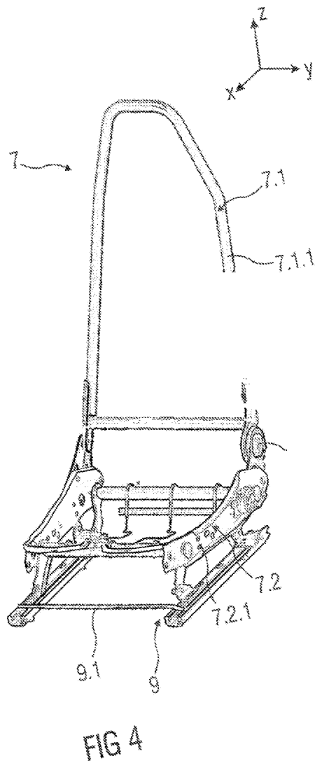

FIG. 4 shows schematically a perspective view of a supporting seat structure for a seat,

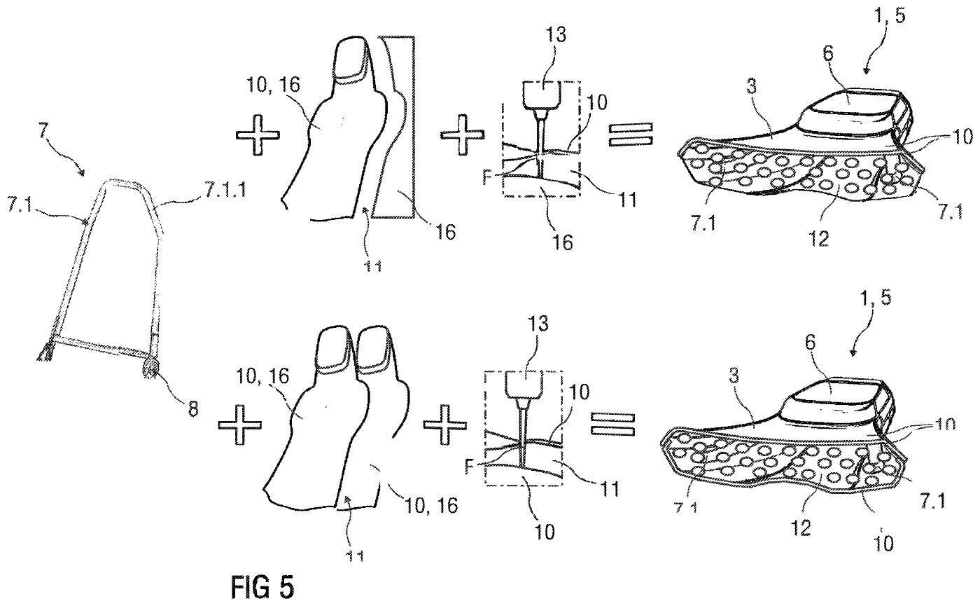

FIG. 5 shows schematically a workflow plan for the production of a molded body for a seat component, in particular a backrest, of a seat,

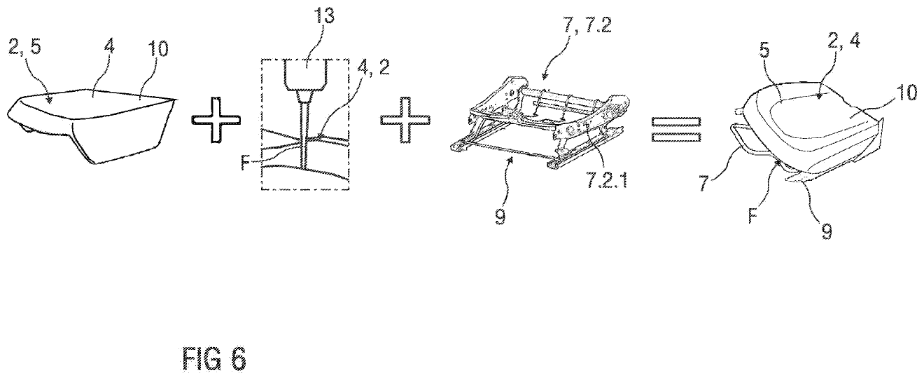

FIG. 6 shows schematically a workflow plan for the production of a molded body for an alternative seat component, in particular a seat part, of a seat,

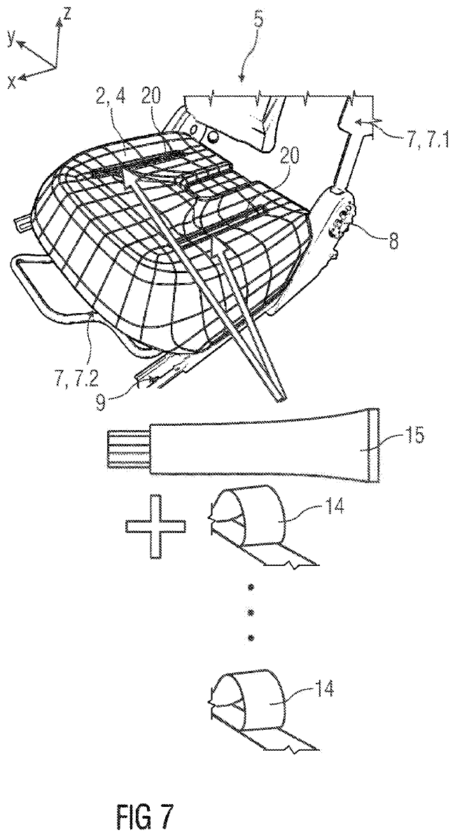

FIG. 7 shows schematically a workflow plan for fastening an attachment element, in particular a fastening means, to a molded body of a seat component, in particular a seat, and

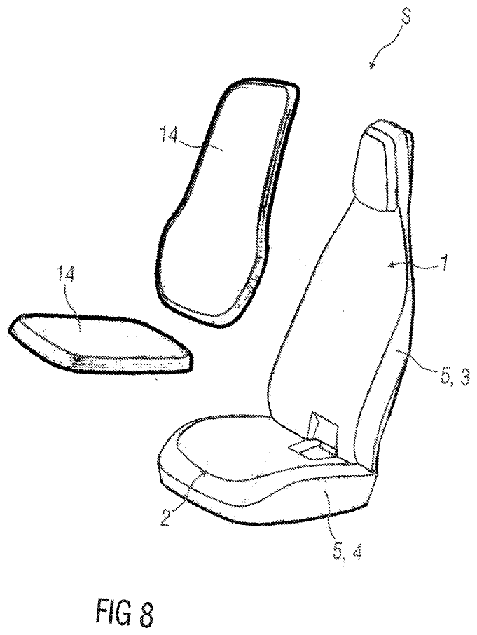

FIG. 8 shows schematically a workflow plan for fastening at least two attachment elements, in particular two additional molded bodies, to another molded body of a seat.

Parts that correspond to one another are identified using the same reference signs in all figures.

A seat S schematically shown in FIG. 1, in particular a vehicle seat, is described below using three spatial directions running perpendicularly to one another. When a seat S is installed in the vehicle, a longitudinal direction x extends largely horizontally and preferably parallel to a vehicle longitudinal direction, which corresponds to the usual direction of travel of the vehicle. A transverse direction y running perpendicularly to the longitudinal direction x is also oriented horizontally in the vehicle and runs parallel to a vehicle transverse direction. A vertical direction z runs perpendicularly to the longitudinal direction x and perpendicularly to the transverse direction y. Where a seat S is installed in the vehicle, the vertical direction z preferably runs parallel to a vehicle vertical axis.

The positional and directional references used, such as front, rear, top, and bottom, for example, refer to a viewing direction of an occupant sitting in the seat S in the normal seating position, wherein the seat S is installed in the vehicle, in a suitable usage position for passenger transportation with an upright backrest 3 and, as customary, is oriented in the direction of travel. However, the seat S may also be installed or moved in a different orientation, for example transversely to the direction of travel.

The seat S comprises two seat components 1, 2. A first seat component 1 is designed as a backrest 3 of the seat S, for example. A second seat component 2 is designed as a seat part 4 of the seat S, for example.

The backrest 3 can be formed with an integrated headrest 6. The headrest 6 is then part of the first seat component 1 and the molded body 5 thereof. Alternatively, the headrest 6 can be designed separately and mounted on the backrest 3 (not shown).

The respective seat component 1, 2 is designed as a molded body 5, in particular as an integral, thermally solidified and three-dimensionally formed, in particular thermoformed, molded body 5.

The respective molded body 5 has a three-dimensional ergonomic shape that is particularly adapted to a contour of a user of the seat S. In particular, a surface of the molded body 5 pointing in the direction of the seat user is ergonomically formed.

The backrest 3 may be fastened to the seat part 4. The backrest 3 may be pivotally fastened to the seat part 4.

FIG. 2 shows the seat S schematically as a partially transparent perspective view. The seat part 4, as a first seat component 1, is formed as a thin seat shell, in particular thermally solidified and three-dimensionally formed, in particular 3D thermoformed. The seat part 4 is shell-shaped. The seat part 4 has a thin, solid seat base part 4.1, which is surrounded at least partially, in particular laterally or circumferentially, by a seat part edge 4.2.

The backrest 3, as a second seat component 2, is formed as a thin seat shell, in particular thermally solidified and three-dimensionally formed, in particular 3D thermoformed. The backrest 3 is shell-shaped. The backrest 3 has a thin, solid backrest base part 3.1, which is surrounded at least partially, in particular laterally, by a backrest part edge 3.2.

FIG. 3 shows schematically another perspective view of the seat S with the backrest 3 and the seat part 4. The seat part edge 4.2 is designed circumferentially.

FIG. 4 shows schematically a perspective view of a supporting seat structure 7 for the seat S. The supporting seat structure 7 may comprise a supporting backrest structure part 7.1 and a supporting seat surface structure part 7.2. The backrest structure part 7.1 is fastened to the seat surface structure part 7.2. In particular, the backrest structure part 7.1 is pivotally fastened to the seat surface structure part 7.2. For example, at least one hinge 8, in particular a pivot hinge or a latch hinge, is provided for pivotally fastening the backrest structure part 7.1 to the seat surface structure part 7.2.

The backrest structure part 7.1 is designed as a separate profile frame 7.1.1. The seat surface structure part 7.2 is designed as a separate profile frame 7.2.1. A seat longitudinal adjustment unit 9, in particular a rail system, can be arranged on and fastened to the profile frame 7.2.1. In order to unlock the seat longitudinal adjustment unit 9, this may comprise an actuating element 9.1, in particular a handle or lever, for operating a lock of the rail system.

FIG. 5 schematically shows a workflow plan for producing one of the molded bodies 5 for the first seat component 1, in particular the backrest 3 of the seat S.

During the process for producing the molded body 5 for the first seat component 1, the supporting backrest structure part 7.1 and at least one nonwoven element 10, or optionally two nonwoven elements 10, are provided.

The nonwoven element 10 in each case is thermally solidified and three-dimensionally formed, in particular thermally solidified and 3D thermo-preformed.

Next, the individual nonwoven element 10 is arranged in a foam mold opposite a mold part 16 of the foam mold, in such a manner that a cavity 11 is formed between the mold part 16 and the nonwoven element 10. In other words, the cavity 11 is designed as a mold cavity on a rear side of the nonwoven element 10, which is particularly shell-shaped. The nonwoven element 10 forms a mold part 16 opposite the mold part 16, and the cavity 11 between them is the mold cavity.

Optionally, two nonwoven elements 10 can be arranged and fixed in respect of one another in the foam mold in such a manner that a cavity 11 is formed between them as a mold cavity. In this exemplary embodiment, the two nonwoven elements 10 each form a mold part 16 of the foam mold.

The supporting backrest structure part 7.1 is arranged in the respective cavity 11.

In a next step, a filling material F, in particular a foam material or foamable material, is injected into the cavity 11, for example by a nozzle 13, which is connected in a form-fitting and/or force-fitting manner to the individual nonwoven element 10 or the two nonwoven elements 10 and forms an inner foam body 12. The supporting backrest structure part 7.1 in this case is foamed into the cavity 11 by the foam material or the foamable material.

The individual nonwoven element 10 or the two nonwoven elements 10 may become, or already be, partially or completely penetrated by the filling material F, or not penetrated by the filling material F, during the filling and foaming of the cavity 11, and they may be connected to the filling material F.

The molded body 5 for the backrest 3 as the first seat component 1 is formed at least from the one thermally solidified and three-dimensionally thermoformed nonwoven element 10 or optionally from the two thermally solidified and three-dimensionally formed, in particular three-dimensionally thermo-preformed, nonwoven elements 10. On the side of the individual nonwoven element 10 facing the cavity 11, a foam material or foamable material is then injected as filling material F. In other words, the individual nonwoven element 10 is only back-molded with the foam material or foamable material on one side, in particular the rear side. The nonwoven element 10 in this case forms a bearing surface or seat surface for a user and the cured foam material forms a rear cover of the respective seat component 1 or 2, in particular of the backrest 3 or the seat part 4.

Optionally, a foam material or foamable material can be injected or introduced between the two nonwoven elements 10 as the filling material F. In this exemplary embodiment, the front nonwoven element 10 then forms a bearing surface or seat surface for a user, and the rear nonwoven element 10 forms a rear cover of the respective seat component 1 or 2, in particular the backrest 3 or the seat part 4.

In both exemplary embodiments with a single nonwoven element 10 or with two nonwoven elements 10, the foam material foams the cavity 11, in particular the cavity 11 formed between the mold part 16 and the individual nonwoven element 10 or the cavity 11 formed between the pre-assembled or pre-fixed nonwoven elements 10 or the gap, and is connected to the individual nonwoven element 10 or the two nonwoven elements 10 in a form-fitting and/or substance-bonded manner. The molded body 5 formed from the one thermally solidified and three-dimensionally formed, particularly thermally pre-solidified and thermoformed, and back-molded nonwoven element 10 or from the two thermally solidified and three-dimensionally formed, particularly thermally pre-solidified and thermoformed, and internally foamed nonwoven elements 10 for the first seat component 1 allows for an integral and three-dimensionally formed seat shell. An integral, three-dimensionally formed seat shell of this kind is highly rigid, thin, and particularly lightweight. An integral, three-dimensionally formed molded body 5 of this kind acts as a seating body or support body, in particular a seat shell or support shell, for the backrest 3 for the back of a seat user. In this case, the individual nonwoven element 10 or one of the two nonwoven elements 10 forms a bearing surface for a user of the molded body 5.

The strength and/or rigidity of the molded body 5 formed from the individual nonwoven element 10 or the nonwoven elements 10 and internally foamed can be adjusted by varying parameters of the production process, in particular the thermoforming and/or injection molding or deep drawing processes, the geometry of the nonwoven element 10 or the nonwoven elements 10, and/or the type and composition of the filling material F and/or the material of the nonwoven element 10 or of the nonwoven elements 10, in particular of a fiber material, for example of a plastic fiber material.

Due to the outer nonwoven element 10 that forms the bearing surface or the outer nonwoven elements 10, one of which forms the bearing surface, the molded body 5 provides pleasant seating comfort, even without additional cushioning and an additional seat cover. As a result of this, a backrest 3 of this kind, reduced to this molded body 5, has a particularly simple structure and can be produced particularly cost-effectively. The molded body 5 is also referred to as a soft seat shell or comfort seat shell.

The nonwoven element 10 in each case is, in particular, a highly rigid, thermoformed, and particularly thin nonwoven fabric.

For example, the molded body 5 of the backrest 3, in particular the backrest base part 3.1 thereof and/or the backrest part edge 3.2 thereof, has/have a thickness of 2 mm, for example. The thickness may vary and lie between 1 mm and 3.5 mm, for example, in particular around 2.5 mm or 3 mm. The backrest part edge 3.2 has a height of, in particular, around 10 mm to 50 mm, for example, from 20 mm to 40 mm, preferably of around 30 mm or 35 mm.

The thermally solidified and three-dimensionally formed nonwoven element 10 in each case is particularly made of a plastic fiber material, in particular of polyester fibers. In addition, the nonwoven element 10 in each case may include polypropylene fibers. The nonwoven elements 10 may be formed from the same plastic fiber material. Alternatively, these nonwoven elements 10 may be formed from different plastic fiber materials. The nonwoven elements 10 may have different strength and/or density. In particular, the nonwoven element 10 in each case may be differently formed at least in parts, in particular having a different density and/or strength.

For example, the nonwoven element 10 in each case may have a grammage of 400 to 1200 grams per square meter, in particular a grammage of 900 grams per square meter. The nonwoven element 10 in each case preferably has a grammage of 850 grams per square meter to 950 grams per square meter.

The thermally solidified and three-dimensionally formed and foam-filled molded body 5 for the backrest 3 and optionally the headrest 6 is/are also referred to as the thermally solidified and thermo-3D-formed seat shell, in particular thermo-3D-formed plastic seat shell or thermo-3D-formed thermo-nonwoven shell.

FIG. 6 shows schematically a workflow plan for the production of a molded body 5 for an alternative second seat component 2, in particular the seat part 4 of the seat S.

In the alternative embodiment, the molded body 5 of the second seat component 2 is formed only from a thermally solidified and three-dimensionally formed nonwoven element 10, which is, for example, back-molded with the filling material F, a foam material, or a foamable material. A molded body 5 of this kind formed from only one thermally solidified and thermoformed and back-molded nonwoven element 10 allows for an integral and three-dimensional thermo-solidified and thermoformed seat shell that can be mounted on a supporting seat structure 7, in particular on the seat surface structure part 7.2, for example on the profile frame 7.2.1 of the seat surface structure part 7.2.

In both embodiments, the thermally solidified and thermoformed nonwoven element 10 forms the seat surface of the respective seat component 1 (=backrest 3) or 2 (=seat part 4) of the seat S. The backrest 3 in this case has a thermally solidified and thermoformed nonwoven element 10 on both sides, both towards the front and also towards the back. In this case, the forward-facing nonwoven element 10 acts as a bearing surface for the back of a seat user. The backward-facing nonwoven element 10 acts as a cover for the backrest 3 towards the rear, for example in the direction of a rear row of seats or a rear seat S. A seat part 4 of the seat S has, for example, a thermally solidified and thermoformed nonwoven element 10 only in the direction of the seat user. In the direction of the vehicle floor, the nonwoven element 10 is back-molded with foam material.

Subsequently, the thermally solidified and thermo-3D-formed and back-molded nonwoven element 10 is mounted with its foam side on the profile frame 7.2.1 to the second seat component 2 and thus to the seat part 4.

FIG. 7 shows schematically a workflow plan for fastening an attachment element 14, in particular by a connecting arrangement with at least one fastening element 15, for example, a Velcro fastening means or an adhesive, to the molded body 5 of the second seat component 2, in particular the seat part 4, in particular the seat base part 4.1.

The attachment element 14 is, for example, a decorative element.

FIG. 8 shows schematically a workflow plan for fastening two attachment elements 14, in particular using fastening elements 15, for example, a Velcro fastening means or a clamping-hook connection, to the molded body 5 of the first seat component 1, especially the backrest 3, and to the molded body 5 of the second seat component 2, especially the seat part 4.

The attachment element 14 is, for example, a cushion or a heating mat, or the like.

In this case, fastening elements 15 that correspond to one another can be provided on the seat components 1 and 2 and on the attachment elements 14, in order to connect them together in a detachable manner.

For example, one of the nonwoven elements 10 and/or the foam body 12 is provided with at least one recess 20. One or more recesses 20 can preferably be introduced on a front side, in particular the seat surface or user surface, of the front nonwoven element 10. Various attachment elements 14 can be passed through or arranged in the recesses 20.

The foam body 12 may already be produced with the recess 20 during the foaming process, for example.

For example, the recesses 20 can be formed subsequently on and/or in the nonwoven element 10. For example, the recesses 20 are formed in and/or on the seat component 1, 2 present as the molded body 5. Fastening elements 15 can be arranged in the recess 20.

The recesses 20 are, for example, through-holes or grooves or slots or the like.

The recesses 20 are design elements, for example, and/or perform a ventilation function and are designed as an air flow opening, for example. In addition or alternatively, the recesses 20 may be designed for routing or embedding heating wires.

Other attachment elements 14 are, for example, cable arrangements, cable harnesses, or plug connector devices.

### LIST OF REFERENCE SIGNS

1 first seat component
2 second seat component
3 backrest
3.1 backrest base part
3.2 backrest part edge
4 seat part
4.1 seat base part
4.2 seat part edge
5 molded body
6 headrest
7 supporting seat structure
7.1 backrest structure part
7.1.1 profile frame
7.2 seat surface structure part
7.2.1 profile frame
8 hinge
9 seat longitudinal adjustment unit
9.1 handle element
10 nonwoven element
11 cavity
12 foam body
13 nozzle
14 attachment element
15 fastening element
16 mold part
20 recess
F filling material
S seat
x longitudinal direction
y transverse direction
z vertical direction

1-16. (canceled)

17. A seat component, comprising:
a seat structure and a molded body,
wherein the molded body comprises at least one thermally solidified and three-dimensionally formed nonwoven element that is back-molded with a foam material or a foamable material,
wherein the seat structure is arranged in a cavity of the at least one nonwoven element and is foamed in by the foam material or the foamable material,
wherein the seat component is a backrest or a seat part of a seat.

18. The seat component as claimed in claim 17, wherein the nonwoven element has different levels of density or strength in parts or wherein two nonwoven elements are provided, wherein one of the nonwoven elements has lower density and/or lower strength than the other nonwoven element at least in parts.

19. The seat component as claimed in claim 17, wherein two nonwoven elements are provided and are arranged opposite one another and form a cavity between them, in which the foam material or the foamable material is injected and the seat structure is foamed in.

20. The seat component as claimed in claim 17, wherein the foam material or the foamable material is connected to the nonwoven element or the nonwoven elements in a form-fitting and/or substance-bonded manner.

21. The seat component as claimed claim 17, wherein the nonwoven element or one of the two nonwoven elements forms a user-facing, three-dimensional, bearing surface.

22. The seat component as claimed in claim 17, wherein the nonwoven element or at least one of the two nonwoven elements is at least partially made of a plastic fiber material.

23. The seat component as claimed in claim 17, wherein the molded body comprises at least one attachment element which is arranged above the nonwoven element or above one of the nonwoven elements and is fixed thereto in a detachable manner.

24. The seat component as claimed in claim 17, wherein the nonwoven element or the two nonwoven elements is/are partially or completely permeated by the foam material or foamable material or is/are not permeated by the foam material or foamable material.

25. The seat component as claimed in claim 17, wherein the nonwoven element or the two nonwoven elements is/are provided with at least one recess.

26. The seat component as claimed in claim 25, wherein the recess is in the shape of a through-hole, a groove or a slot.

27. A vehicle seat, comprising at least one of the one seat components as claimed in claim 17.

28. A method for producing a seat component, comprising:
at least one nonwoven element is thermally solidified and three-dimensionally formed into a molded body,
and then
the one nonwoven element is arranged opposite at least a part of a foam mold and a cavity is formed between them, in which a seat structure is arranged and a foam material or foamable material is injected, wherein the seat structure is foamed in by the foam material or foamable material,
wherein the seat component is a backrest or a seat part of a seat.

29. The method as claimed in claim 28, wherein two nonwoven elements are thermally solidified and three-dimensionally formed into a molded body and are then arranged and fixed in respect of one another in such a manner that a cavity is formed between them, in which the seat structure is arranged and a foam material or foamable material is injected, wherein the seat structure is foamed in by the foam material or the foamable material.

30. The method as claimed in claim 28, wherein the foam material or the foamable material is connected in a form-fitting and/or force-fitting manner to the nonwoven element or the two nonwoven elements.

31. The method as claimed in claim 28, wherein the nonwoven element or the two nonwoven elements become, or already are, partially or completely penetrated by the foam material or the foamable material, or are not penetrated by the foam material or foamable material, during the filling and foaming of the cavity.

32. The method as claimed in claim 28, wherein at least one recess is formed during the foaming process or subsequently on and/or in the nonwoven element or both nonwoven elements.
